(19) United States
(12) Patent Application Publication
(10) Pub. No.: US 2025/0390008 A1
(43) Pub. Date: Dec. 25, 2025

(54) MOUNTING ASSEMBLY

(71) Applicant: Andrew Simon, Ompah (CA)

(72) Inventor: Andrew Simon, Ompah (CA)

(21) Appl. No.: 19/243,616

(22) Filed: Jun. 19, 2025

(30) Foreign Application Priority Data
Jun. 19, 2024 (CA) 3242294

(51) Int. Cl. G03B 17/56; B60R 11/00; B60R 11/02; F16M 11/04; F16M 11/14; F16M 11/20; F16M 13/02

(52) U.S. Cl. CPC G03B 17/561; B60R 11/0211; F16M 11/041; F16M 11/14; F16M 11/2057; F16M 13/022; B60R 2011/001

(57) ABSTRACT

A mounting assembly is usable with a vehicle device, such as a steering wheel of a vehicle, and a camera assembly. The mounting assembly is configured to hold a camera assembly in a desired position relative to the vehicle device. The mounting assembly comprises an elongated member having a clamping system configured to affix to the vehicle device, an adjustable arm assembly connected to the elongated member, and a camera connection device connected to the adjustable arm and having a mount for receiving the camera assembly.

### CROSS-REFERENCE TO RELATED APPLICATION

This application claims the benefit of Canadian Patent Application No. CA 3,242,294, entitled “MOUNTING ASSEMBLY” and filed Jun. 19, 2024, which is incorporated herein by reference.

### TECHNICAL FIELD

This document relates to the technical fields of (and is not limited to): a mounting assembly for use with a vehicle device (such as a steering wheel) of a vehicle and with a camera assembly; a vehicle for use with a camera assembly, the vehicle comprising a vehicle device (such as a steering wheel), and a mounting assembly configured to be connectable to the vehicle device, and also configured to be connectible to the camera assembly; a camera assembly for use with a vehicle device (such as a steering wheel) of a vehicle, the camera assembly comprising a mounting assembly configured to be connectable to the vehicle device, and also configured to be connectible to the camera assembly; a method for mounting a mounting assembly onto a vehicle device (such as a steering wheel) of a vehicle and a camera assembly; and a method for recording an image (such as a video recording) with a camera assembly mounted to a mounting assembly that is mountable to a vehicle device (such as a steering wheel).

### BACKGROUND

Private investigators and/or individuals with jobs requiring them to record video from their vehicles may need to film for extended periods. Holding a camera steady with just your hands can be cumbersome. A traditional tripod could keep the camera still for a long time while outside of a vehicle. Such a tripod traditionally contains a head containing a ball head, a camera mount, a camera plate, a quick-release plate, video cage or other suitable mount for a camera. However, a traditional tripod isn't effective in a vehicle due to its reliance on legs for stability, which can't be properly used in the confines of a car cabin. Private investigators need to produce steady, explicit videos that might be used as evidence in the courts. There are known clamps that can securely hold a camera in place; however, these clamps aren't meant for securely holding a heavy camera steady or for easy filming from the various vehicle windows.

When a private investigator needs to hold the camera for an extended period, they may record shaky videos. It is advantageous for the private investigator to record videos as steadily and stealthily as possible. Also, while filming, the private investigator cannot use their hands for anything else, such as drinking water, using their phone, or taking notes.

The known devices do not accommodate the type of camera a private investigator might use. Private investigators' cameras are heavier and bulkier, and the known devices on the market cannot support this heavier camera weight. Additionally, the known devices have limited points of contact, which makes them very unsteady. As a result, it is difficult to aim the camera with them in an exact, desired position or orientation to capture clear, steady and unblurry video.

### SUMMARY

A mounting assembly is provided to mitigate, at least in part, at least one problem associated with the existing technology, and in accordance with a first embodiment, there is provided a mounting assembly for use with a vehicle device (such as a steering wheel) of a vehicle and with a camera assembly, and the mounting assembly comprises a synergistic combination of elements.

In accordance with a second embodiment, there is provided a vehicle for use with a camera assembly, the vehicle comprising a vehicle device (such as a steering wheel), and a mounting assembly configured to be connectable to the vehicle device and also configured to be connectible to the camera assembly.

In accordance with a third embodiment, there is provided a camera assembly for use with a vehicle device (such as a steering wheel) of a vehicle, the camera assembly comprising a mounting assembly configured to be connectable to the vehicle device and also configured to be connectible to the camera assembly.

In accordance with a fourth embodiment, there is provided a method for mounting a mounting assembly onto a vehicle device (such as a steering wheel) of a vehicle and a camera assembly, and the method comprises a synergistic combination of operations.

In accordance with a fifth embodiment, there is provided a method for recording an image (such as a video recording) with a camera assembly mounted to a mounting assembly which is mountable to a vehicle device (such as a steering wheel) of a vehicle, and the method comprises a synergistic combination of operations.

In one example aspect, there is provided a mounting assembly for use with a vehicle device of a vehicle and for use with a camera assembly, the mounting assembly comprising: an elongated member having a clamping system configured to affix to the vehicle device; an adjustable arm assembly connected to the elongated member; and a camera connection device connected to the adjustable arm and having a mount for receiving the camera assembly.

In another example aspect, there is provided a mounting assembly wherein the adjustable arm can be pivotable relative to the elongated member. The camera connection device can be pivotable relative to the elongated member and/or the adjustable arm.

In another example aspect, there is provided a mounting assembly wherein the clamping system of the elongated member comprises spaced-apart hooks configured to hook onto the vehicle device.

In another example aspect, there is provided a mounting assembly wherein the clamping system of the elongated member further comprises a clamp assembly configured to clamp onto the vehicle device.

In another example aspect, there is provided a mounting assembly wherein the clamp assembly comprises a clamp tightening handle.

In another example aspect, there is provided a mounting assembly wherein the adjustable arm assembly comprises a first arm and a second arm;

In another example aspect, there is provided a mounting assembly wherein the first arm and the second arm are pivotably connected together via an arm tightening handle.

In another example aspect, there is provided a mounting assembly wherein the second arm comprises a pivot assembly having a pivot tightening handle.

In another example aspect, there is provided a mounting assembly wherein the camera connection device is connected to the pivot assembly.

In another example aspect, there is provided a mounting assembly wherein the pivot tightening handle is configured to set the pivot of the camera connection device.

In yet a further example aspect, there is provided a vehicle for use with the camera assembly, the vehicle comprising the vehicle device and the mounting assembly.

In another example aspect, there is provided a method for mounting a mounting assembly onto a steering wheel of a vehicle and a camera assembly, the method comprising: placing the mounting assembly onto the steering wheel; fitting a pair of spaced-apart hooks onto opposite sides of the steering wheel; clamping a clamp assembly to another contact point of the steering wheel; extending an adjustable arm assembly to a convenient position; attaching the camera assembly to a camera connection device; and orienting the camera assembly in a desired direction.

In another example aspect, there is provided a method wherein the step of extending an adjustable arm assembly to a convenient position further comprises the steps of: loosening one or more tightening handles of the mounting assembly; adjusting the adjustable arm assembly to suit spatial requirements of the camera assembly; pointing the camera assembly at a subject of interest; and tightening the tightening handles.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in a simplified form, further described below in the Detailed Description. This Summary is not intended to identify potential key or possible essential features of the disclosed subject matter and is not intended to describe each disclosed embodiment or every implementation of the disclosed subject matter. As this description proceeds, many other novel advantages, features, and relationships will become apparent. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings in which:

FIG. 1 depicts a front perspective view of an embodiment of a mounting assembly on a steering wheel;

FIG. 2 depicts a side perspective view of the mounting assembly of FIG. 1 on a steering wheel;

FIG. 3 depicts another side perspective view of the mounting assembly of FIG. 1 on a steering wheel;

FIG. 4 depicts a perspective view of the mounting assembly of FIG. 1 on a steering wheel;

FIG. 5 depicts another perspective view of the mounting assembly of FIG. 1;

FIG. 6 depicts yet another perspective view of the mounting assembly of FIG. 1;

FIG. 7 depicts yet another perspective view of the mounting assembly of FIG. 1.

The drawings are not necessarily to scale and may be illustrated by phantom lines, diagrammatic representations and fragmentary views. In certain instances, unnecessary details may have been omitted to understand the embodiments (details that render other details difficult to perceive). Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements to facilitate an understanding of the various disclosed embodiments. In addition, standard and well-understood elements that are useful in commercially feasible embodiments are often not depicted to provide a less obstructed view of the embodiments of the present disclosure.

### DETAILED DESCRIPTION

The following detailed description is merely exemplary and is not intended to limit the described embodiments or the application and uses of the described embodiments. As used, the word “exemplary” or “illustrative” means “serving as an example, instance, or illustration.” Any “exemplary” or “illustrative” implementation is not necessarily to be construed as preferred or advantageous over other implementations. All of the implementations described below are exemplary implementations provided to enable persons skilled in the art to make or use the embodiments of the disclosure. They are not intended to limit the scope of the disclosure. The claims define the scope of the disclosure. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings and described in the following specification are exemplary embodiments (examples), aspects and/or concepts defined in the appended claims. Hence, dimensions and other physical characteristics relating to the embodiments disclosed are not to be considered limiting unless the claims expressly state otherwise. It is understood that the phrase “at least one” is equivalent to “a”. The aspects (examples, alterations, modifications, options, variations, embodiments or any equivalent thereof) are described regarding the drawings. It should be understood that the disclosure is limited to the subject matter provided by the claims and that the disclosure is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless expressly stated otherwise.

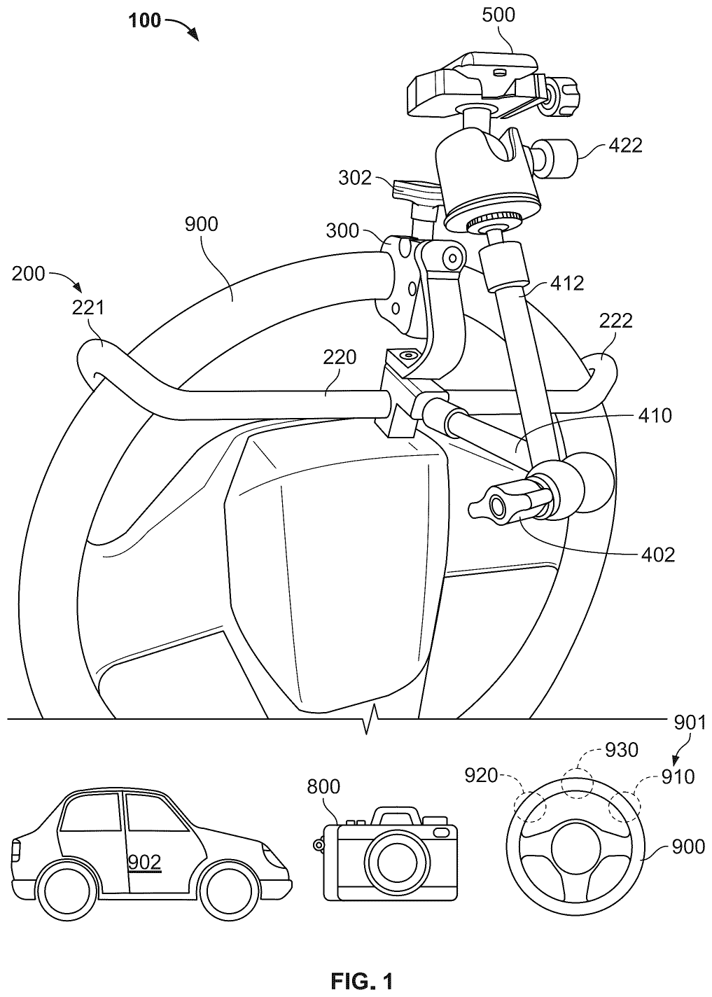

FIG. 1 depicts a front perspective view of an embodiment of a mounting assembly 100.

In accordance with a first example embodiment, as depicted in FIG. 1, a mounting assembly 100 is provided for use with a vehicle device (such as a steering wheel 900) of vehicle 902 and for use with a camera assembly 800. The mounting assembly comprises a synergistic collection of components.

In accordance with a second example embodiment, as depicted in FIG. 1, a vehicle 902 is for use with a camera assembly 800. The vehicle 902 includes and is not limited to a vehicle device (such as a steering wheel 900). The vehicle 902 also includes a mounting assembly 100 configured to be connectable to the vehicle device and also configured to be connectible to the camera assembly 800. The mounting assembly comprises a synergistic collection of components.

In accordance with a third example embodiment, as depicted in FIG. 1, a camera assembly 800 for use with a vehicle device (such as a steering wheel 900) of a vehicle 902, the camera assembly 800 comprising a mounting assembly 100 configured to be connectable to the vehicle device, and also configured to be connectible to the camera assembly 800. The mounting assembly comprises a synergistic collection of components.

The mounting assembly 100 advantageously can allow or help a user to position the camera assembly 800 in a specific or desired orientation or direction in such a way that the camera assembly 800 can record or obtain a steady image, such as a steady hands-free video recording.

The mounting assembly 100 advantageously can permit or allow a user to use the camera assembly 800 to record or film in many orientations and/or directions out of a window (such as the front windscreen or a side passenger window) of a vehicle 902.

Referring to the embodiment as depicted in FIG. 1, the mounting assembly 100 includes a contact-attachment assembly 200 configured to be selectively securely engageable and/or attachable to a securable contact point 901 (also called a portion of) a steering wheel 900 of a vehicle 902. It will be appreciated that the term “securable contact point” can include, or is equivalent to, the term “at least one securable contact point”.

Referring to the example embodiment as depicted in FIG. 1, the securable contact point 901 can include a first securable contact point 910, a second securable contact point 920 and a third securable contact point 930 configured to be selectively securely attachable to the mounting assembly 100; this arrangement improves the stability and sturdiness of the mounting assembly 100 once attached to the steering wheel 900. The first securable contact point 910, the second securable contact point 920 and the third securable contact point 930 are spaced apart from each other and are positioned on the circular frame of the steering wheel 900.

Referring to the example embodiment as depicted in FIG. 1, the contact-attachment assembly 200 includes an elongated member 220 with a pair of spaced-apart hooks (221, 222) positioned on opposite ends of the elongated member 220. In accordance with an example embodiment, the elongated member 220 is telescopic. In accordance with another embodiment, the elongated member 220 is non-telescopic. The pair of spaced-apart hooks (221, 222) is configured to frictionally grip opposite portions of the steering wheel 900, which improves the stability of the mounting assembly 100.

Referring to the example embodiment as depicted in FIG. 1, the mounting assembly 100 further includes a clamp assembly 300 attached directly or indirectly to a portion of the elongated member 220. The clamp assembly 300 can include a clamp tightening handle 302. The clamp assembly 300 can be positioned at and attached to the middle of the elongated member 220. The clamp assembly 300 is configured to be attached to a portion or contact point of the steering wheel 900. The pair of spaced-apart hooks (221, 222) and the clamp assembly 300 are each configured to be selectively attached to respective portions or contact points of the steering wheel 900 for example at any of the securable contact points.

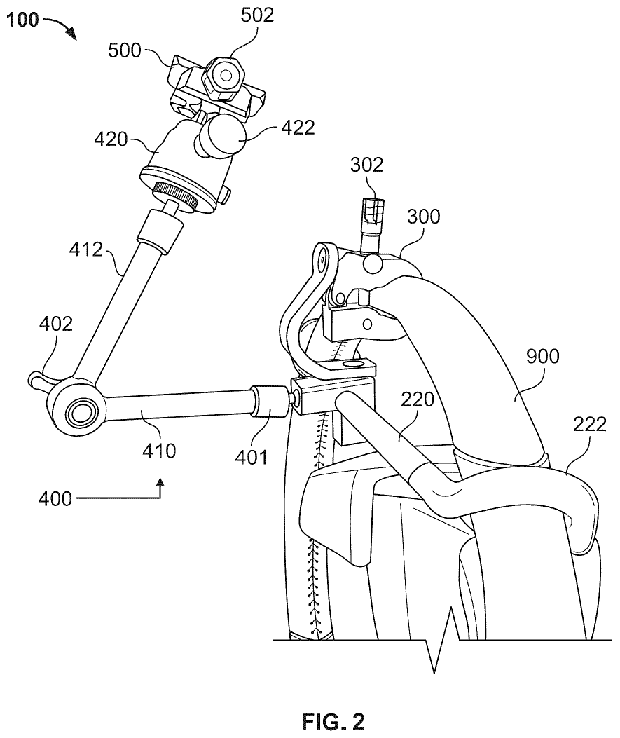

Referring to the example embodiment as depicted in FIG. 2, the mounting assembly 100 also includes an adjustable arm assembly 400 configured to be attached directly or indirectly to the contact-attachment assembly 200, such as to the elongated member 220. The adjustable arm assembly 400 is attached to and extends from a mid-section of the elongated member 220. The adjustable arm assembly 400 includes a first arm 410 and a second arm 412 pivotally coupled to the first arm 410. The adjustable arm assembly 400 can include an arm tightening handle 402. The adjustable arm assembly 400 can include a pivot assembly 420 operatively coupled, such as by a ball joint device. The pivot assembly 420 can include a pivot tightening handle 422. The adjustable arm assembly 400 can also include a base pivot assembly 401 operatively coupled to the elongated member 220.

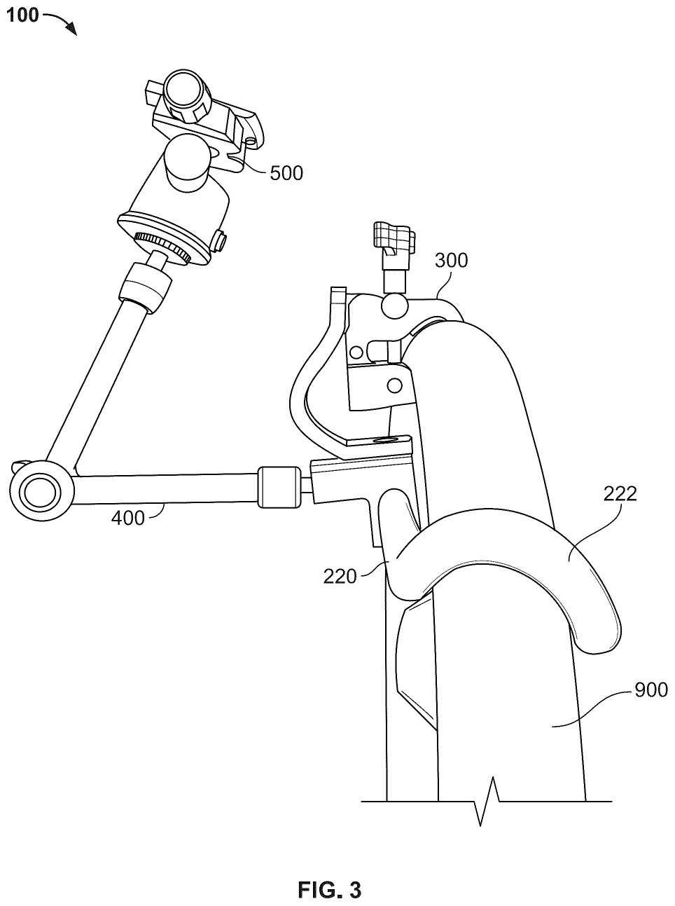

Referring to the example embodiment as depicted in FIG. 3, the mounting assembly 100 also includes a camera connection device 500 that can be configured to be pivotally supported by the adjustable arm assembly 400. The camera connection device 500 can be configured to be pivotally supported by the pivot assembly 420. The camera connection device 500 is configured to securely attach to a camera assembly 800. The camera connection device 500 is configured to permit selective rotation and/or orientation of the camera assembly 800. The camera connection device 500 can include a ball head, a camera mount, a camera plate, a quick-release plate, video cage or other suitable mount. As shown in FIG. 2, the camera connection device 500 can include a connection tightening handle 502, which can be configured to secure the attachment of the camera assembly 800 to the camera connection device 500.

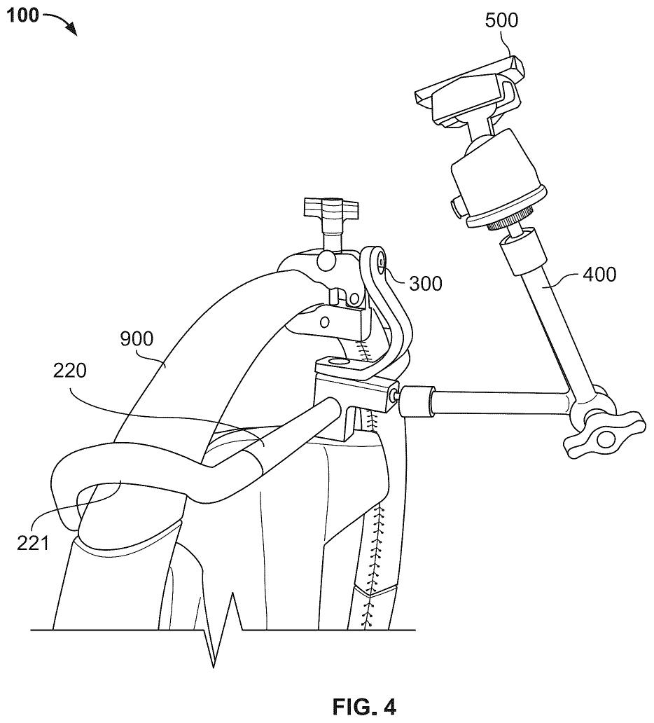

Referring to the example embodiment as depicted in FIG. 4, the adjustable arm assembly 400 and the camera connection device 500 (also called a camera mount) are configured to facilitate improved and/or precise aiming of the camera assembly 800 relative to a desired object or target to be recorded by the camera assembly 800.

Referring to the example embodiment as depicted in FIG. 1, in accordance with a example embodiment, the mounting assembly 100 can advantageously provide at least one or more of (A) the contact-attachment assembly 200 configured to have at least three connection points, (B) the adjustable arm assembly 400 configured for convenient positioning of the camera assembly 800, and/or (C) the camera connection device 500 configured to facilitate precise aiming of the camera assembly 800.

Referring to the embodiment as depicted in FIG. 1, the components of the mounting assembly 100 can be made of any suitable material, such as metal, plastic, etc.

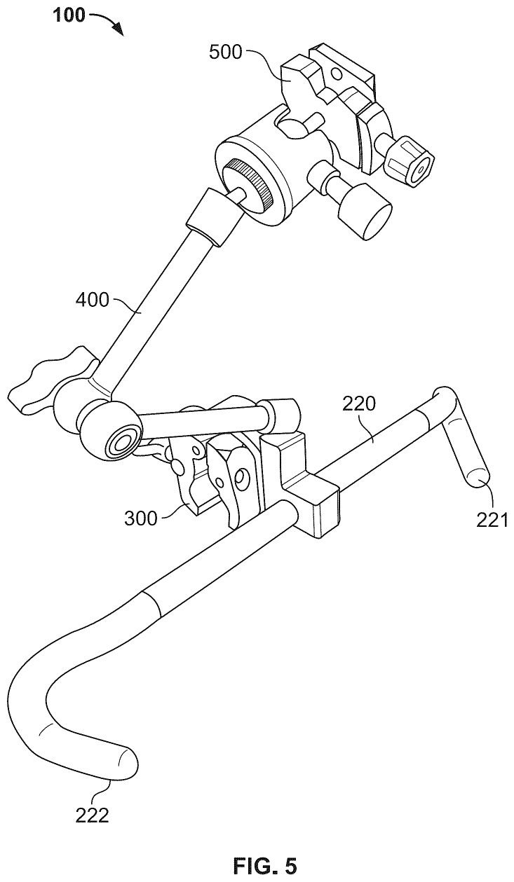

FIG. 5 depicts another perspective view of the mounting assembly 100 of FIG. 1, with a view of a possible arrangement of the elongated member 220 containing the spaced-apart hooks 221, 222 relative to the adjustable arm assembly 400 and camera connection device 500.

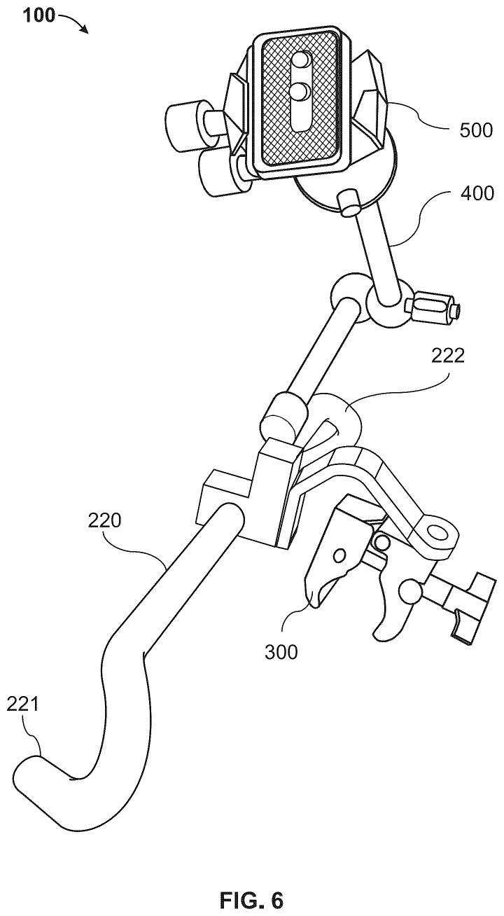

FIG. 6 depicts yet another perspective view of the mounting assembly 100 of FIG. 1, with a view of a possible arrangement and moveability of the elongated member 220 containing the spaced-apart hooks 221, 222 relative to the clamp assembly 300, adjustable arm assembly 400 and camera connection device 500.

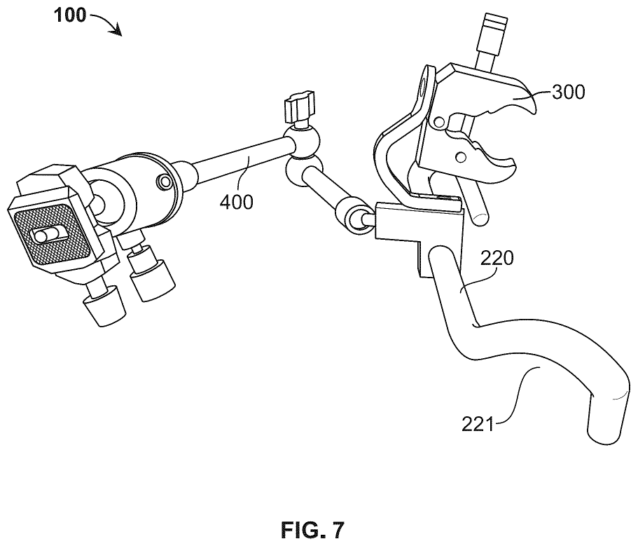

FIG. 7 depicts yet another perspective view of the mounting assembly 100 of FIG. 1, with a view of a possible arrangement and moveability of the elongated member 220 containing the spaced-apart hooks 221, 222 relative to the clamp assembly 300, and adjustable arm assembly 400.

### Installation Operation

Referring to the embodiment as depicted in FIG. 1, a method is used to securely mount a mounting assembly 100 onto a vehicle device (such as a steering wheel 900) of a vehicle 902 and a camera assembly 800.

In one example embodiment, the method is for mounting the mounting assembly 100 with a vehicle device (such as a steering wheel 900) of vehicle 902 and with a camera assembly 800. A user securely places the mounting assembly 100 onto the steering wheel 900 of vehicle 902. The user urges or forces the pair of spaced-apart hooks (221, 222) onto the opposite sides of the steering wheel 900. Once the pair of spaced-apart hooks (221, 222) is frictionally fitted to the steering wheel 900, the user aligns and engages the clamp assembly 300 with another contact point of the steering wheel 900. The user tightens the clamp assembly 300 with clamp tightening handle 302 to secure the mounting assembly 100 on the steering wheel 900. The user extends the adjustable arm assembly 400 to a convenient level or position. The user attaches the camera assembly 800 to the camera connection device 500 via a ball head, a camera mount, a camera plate, a quick-release plate, video cage or other suitable mount, which is attached to and supported by the adjustable arm assembly 400.

### Use Operation

Referring to the example embodiment as depicted in FIG. 1, an example method for recording an image (such as a video recording) is provided with a camera assembly 800 mounted to a mounting assembly 100, which is mountable to a vehicle device (such as a steering wheel 900) of a vehicle 902. Such a camera can also be used for still images.

After a user securely places the mounting assembly 100 onto the steering wheel 900 of the vehicle 902 and securely mounts the camera assembly 800 to the mounting assembly 100, the user can aim or orient the camera assembly 800 in the desired direction.

The method includes the user loosening one or both of the tightening handles (arm tightening handle 402, pivot tightening handle 422) of the mounting assembly 100, adjusting the adjustable arm assembly 400 to suit the spatial requirements of the camera assembly 800, pointing the camera assembly 800 at a subject of interest, and tightening the tightening handles as needed to thereby secure the camera assembly 800.

The user can record an image (such as a video or still image) with the camera assembly 800 securely mounted to the mounting assembly 100, which is securely mounted to a vehicle device (such as a steering wheel 900) of vehicle 902.

Following from the above description, it should be apparent to those of ordinary skill in the art that, while the methods and apparatuses herein described constitute exemplary embodiments of the present invention, the invention described herein is not limited to any precise embodiment and that changes can be made to such embodiments without departing from the scope of the invention as defined by the claims. Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

### LISTING OF PART NUMBERS

100 mounting assembly
200 contact-attachment assembly
220 elongated member
221 spaced-apart hooks
222 spaced-apart hooks
300 clamp assembly
302 clamp tightening handle
400 adjustable arm assembly
401 base pivot assembly
402 arm tightening handle
410 first arm
412 second arm
420 pivot assembly
422 pivot tightening handle
500 camera connection device
502 connection tightening handle
800 camera assembly
900 steering wheel
901 securable contact point
902 vehicle
910 first securable contact point
920 second securable contact point
930 third securable contact point

What is claimed is:

1. A mounting assembly for use with a vehicle device of a vehicle and for use with a camera assembly, the mounting assembly comprising:
an elongated member having a clamping system configured to affix to the vehicle device;
an adjustable arm assembly connected to the elongated member; and
a camera connection device connected to the adjustable arm and having a mount for receiving the camera assembly.

2. The mounting assembly of claim 1 wherein the adjustable arm is pivotable relative to the elongated member.

3. The mounting assembly of claim 1 wherein the camera connection device is pivotable relative to the elongated member and/or the adjustable arm.

4. The mounting assembly of claim 1 wherein the clamping system of the elongated member comprises spaced-apart hooks configured to hook onto the vehicle device.

5. The mounting assembly of claim 4 wherein the clamping system of the elongated member further comprises a clamp assembly configured to clamp onto the vehicle device.

6. The mounting assembly of claim 5 wherein the clamp assembly comprises a clamp tightening handle.

7. The mounting assembly of claim 1 wherein the adjustable arm assembly comprises a first arm and a second arm.

8. The mounting assembly of claim 7 wherein the first arm and the second arm are pivotably connected together via an arm tightening handle.

9. The mounting assembly of claim 7 wherein the second arm comprises a pivot assembly having a pivot tightening handle.

10. The mounting assembly of claim 9 wherein the camera connection device is connected to the pivot assembly.

11. The mounting assembly of claim 9 wherein the pivot tightening handle is configured to set the pivot of the camera connection device.

12. A vehicle for use with the camera assembly, the vehicle comprising:
the vehicle device and the mounting assembly of claim 1.

13. A method for mounting a mounting assembly onto a steering wheel of a vehicle and a camera assembly, the method comprising:
placing the mounting assembly onto the steering wheel;
fitting a pair of spaced-apart hooks onto opposite sides of the steering wheel;
clamping a clamp assembly to another contact point of the steering wheel;
extending an adjustable arm assembly to a convenient position;
attaching the camera assembly to a camera connection device; and
orienting the camera assembly in a desired direction.

14. The method of claim 13 wherein the step of extending an adjustable arm assembly to a convenient position further comprises the steps of:
loosening one or more tightening handles of the mounting assembly;
adjusting the adjustable arm assembly to suit spatial requirements of the camera assembly;
pointing the camera assembly at a subject of interest; and
tightening the tightening handles.
